(19) United States
(12) Patent Application Publication
(10) Pub. No.: US 2008/0207808 A1
(43) Pub. Date: Aug. 28, 2008

(54) Novel mechanism for immiscible polymer blend compatibilization

(76) Inventors: David Abecassis, Huntington, NY (US); Miriam Rafailovich, Plainview, NY (US)

Correspondence Address: Thomas A. O'Rourke;Bodner & O'Rourke, 425 Broadhollow Road, Melville, NY, 11747, US

(21) Appl. No.: 11/799,049

(22) Filed: Apr. 30, 2007

Related U.S. Application Data
(60) Provisional application No. 60/795,711, filed on Apr. 29, 2006.

(51) Int. Cl. C08K 5/5415

(52) U.S. Cl. 524/262

(57) ABSTRACT

A method of compatibilizing immiscible polymers using the mechanical deformation of quaternary amine treated organoclay particles is described. The mechanism decreases the interstitial energy resulting from immiscible polymer domain interfaces into stored mechanical energy. The polymer domains in the immiscible blend get smaller and the resulting compatibilized microcomposite/nanocomposite blend has superior mechanical properties over non compatibilized blends controls of the same materials.

The present application claims priority on provisional patent application Ser. No. 60/795,711, filed Apr. 29, 2006, the disclosures of which are incorporated herein by reference.

### FIELD OF THE INVENTION

The present invention is directed to the field of blends of organoclays and immiscible polymers as well as to improved methods of making these blends.

### BACKGROUND OF THE INVENTION

Common clays are naturally occurring minerals and have a natural variability in their makeup. Natural clays also vary in their purity and the purity of the clay can affect final properties. Many clays are aluminosilicates, which have a sheet-like (layered) structure, and consist of silica SiO₄ tetrahedra bonded to alumina AlO₆ octahedra in a variety of ways. A 2:1 ratio of the tetrahedra to the octahedra results in smectite clays, the most common of which is montmorillonite. Other metals such as magnesium may replace the aluminium in the crystal structure. Depending on the precise chemical composition of the clay, the sheets of clay crystals bear a charge on the surface and edges, this charge being balanced by counter-ions, which reside in part in the inter-layer spacing of the clay. The thickness of the layers (platelets) is of the order of 1 nm and aspect ratios are high, typically 100-1500. The clay platelets are nanoparticulate. In the context of nanocomposites, the molecular weight of the platelets (ca. 1.3×10⁸) is considerably greater than that of typical commercial polymers. The clays often have very high surface areas, up to hundreds of m² per gram. The clays are also characterized by their ion (e.g. cation) exchange capacities, which can vary widely. One important consequence of the charged nature of the clays is that they are generally highly hydrophilic species and therefore naturally incompatible with a wide range of polymer types. A necessary prerequisite for successful formation of polymer-clay nanocomposites is therefore alteration of the clay polarity to make the clay “organophilic”. An organophilic clay can be produced from a normally hydrophilic clay by ion exchange with an organic cation such as an alkylammonium ion. Organoclays are used in a wide variety of applications. These applications can include paint additives, water treatment, the removal of oil and grease. Montmorillonite is the most common type of clay used for nanocomposite formation; however, other types of clay can also be used depending on the precise properties required from the product. These clays include hectorites (magnesiosilicates), which contain very small platelets, and synthetic clays (e.g. hydrotalcite), which can be produced in a very pure form.

One area where organoclays have recently received renewed interest is in the area of organoclay based nanocomposites. Organoclays are frequently manufactured by modifying bentonite with quaternary amines, a type of surfactant that contains a nitrogen ion. The nitrogen end of the quaternary amine, the hydrophilic end, is positively charged, and ion exchanges onto the clay platelet for sodium or calcium. The amines used are of the long chain type with 12-18 carbon atoms. After some 30 per cent of the clay surface is coated with these amines it becomes hydrophobic and, with certain amines, organophilic. The main component of organoclay is bentonite, a chemically altered volcanic ash that consists primarily of the clay mineral montmorillonite. The properties of the organoclay nanocomposite usually depends on whether the final material required is in the form of an intercalated or exfoliated hybrid. In the case of an intercalate, the organic component is inserted between the layers of the clay such that the inter-layer spacing is expanded, but the layers still bear a well-defined spatial relationship to each other. In an exfoliated structure, the layers of the clay have been completely separated and the individual layers are distributed throughout the organic matrix. A third alternative is the use of the clay as a conventional filler. This is usually a dispersion of complete clay particles (tactoids) within the polymer matrix.

### OBJECTS OF THE INVENTION

It is an object of the invention to provide improved blends of immiscible polymers.

It is an object of the invention to provide more homogeneous blends of immiscible polymers.

It is also an object of the invention to reduce interstitial energy between domains of immiscible polymers.

It is another object of the invention to provide a nano-scale physico-mechanical device for absorbing interstitial energy at polymer blend domain interfaces.

It is a further object of the invention to provide organoclay containing blends with improved properties.

It is a still further object of the invention to provide methods of forming improved blends of immiscible polymers.

It is still another object of the invention to use nanoclays to produce immiscible polymer/polymer nanocomposites.

It is a still further object of the invention to provide a nano-scale mechanical device through the use of an organoclay.

### SUMMARY OF THE INVENTION

The present invention is directed to methods of compatibilizing immiscible polymers and the blends so formed. There are a variety of polymers that, due to their structure and/or composition, do not form homogeneous blends. When these polymers are melted and blended together the immiscible polymers form an interface where the domains of each individual polymer are separated from the domains of the other immiscible polymer in the blend. In accordance with the present invention, immiscible polymers may be blended together to create significantly more homogeneous composition of immiscible polymers than heretofore have been achieved. The blends of the present invention are compositions of an organoclay with two or more immiscible polymers. In one embodiment two or more immiscible polymers are melt blended together to form a mixture; to the mixture an organoclay is added. The organoclay is preferably a quaternary amine treated clay.

As the mechanism of the present invention is presently understood, the organoclay absorbs interstitial energy at the surface interface between the domains of the immiscible polymers. The absorption of the interstitial energy causes the domains of the immiscible polymers to shrink compared to blends without the organoclay present to produce a more homogeneous blend. The organoclay particle bends as there is a reduction of the interstitial tension between the immiscible polymers The balance of the bending energy of the clay particle with the reduction of interfacial tension occurs according to the formula where F=bending force=absorbed interstitial energy. r=radius distance of bend from fulcrum point to distance traveled by crystal in bending:

F=γ(n−m)1²+γ′m 1²+m Fbending

m=3V/2r 1²

F bending=Ehζ⁴

1²

r=α1 where α=(5Eh_)^{1/4}/(4(γ−γ′))

When γ larger then the blend is more immiscible
n=number of exfoliated clay platelets
m=non exfoliated platelets or tactoids
sigma=interstitial energy
E=flexular modulus
h=Planks constant
gamma=interstitial energy of polymer A before an organoclay is added
gamma prime=interstitial energy of polymer after an organoclay is added

In measuring the glass transition temperature of immiscible polymers mixed in the absence of an organoclay, depending on the number of immiscible polymers being blended there are a plurality of peaks demonstrating that the blend is heterogeneous and not a relatively uniform blend. However, the blends of immiscible polymers with an organoclay blended in accordance with the present invention yield a single peak showing the presence of a homogeneous blend of immiscible polymers.

The preferred organoclays are smectite clays treated with an organic component preferably a quaternary amine. Suitable quaternary amine treated clays are those sold by Southern Clay Products and described in U.S. Pat. Nos. 6,787,592; 6,787,592; 6,730,719; 6,271,298 and 6,036,765, the disclosures of which are incorporated herein by reference. The quaternary amine preferably has one or more functional groups consisting of amino, carboxyl, acythalide acyloxy, hydroxyl, isocyanate ureido, halo, epoxy and epichlorohydren. The organoclay preferably has been exfoliated into polymer matrix. A preferred quaternary ammonium organoclay compound is one made from a monoester, a diester or trimester quaternary ammonium compound or blends thereof. Another preferred organoclay is one that is the reaction product of a smectite clay with a quaternary onium compound mixture. The quaternary onium compound mixture can include a diester quaternary ammonium compound mixed with an additional quaternary ammonium compound. The additional quaternary ammonium compound can be a triester quaternary ammonium compound, a monoester quaternary ammonium compound, or mixtures thereof. The diester quaternary ammonium compound preferably is present as greater than 55 wt. % of the quaternary onium compound mixture. There may be an additional quaternary ammonium compound that is a triester quaternary ammonium compound. Preferably, the triester quaternary ammonium compound is less than 25 wt. % of the quaternary onium compound mixture.

The fatty acids corresponding to the esters of the diester quaternary ammonium compound and the additional quaternary ammonium compound preferably have a degree of unsaturation such that the iodine value is from about 20 to about 90. In one embodiment, the additional quaternary ammonium compound is a triester quaternary ammonium compound, and the diester quaternary ammonium compound is greater than 60 wt. % of the quaternary onium mixtures, the triester quaternary ammonium compound is less than 20 wt. % of the quaternary onium mixture, and the fatty acids corresponding to the esters in the diester quaternary ammonium compound and the additional quaternary ammonium compound have a degree of unsaturation such that the iodine value is from about 30 to about 70. In another embodiment, there is an additional quaternary ammonium compound that is a triester quaternary ammonium compound, and the diester quaternary ammonium compound is greater than 62 wt. % of the quaternary onium mixture, the triester quaternary ammonium compound is less than 17 wt. % of the quaternary onium mixture and the fatty acids corresponding to the esters in the diester quaternary ammonium compound, and the additional quaternary ammonium compound have a degree of unsaturation such that the iodine value is from about 40 to about 60. In a still further embodiment, the additional quaternary ammonium compound is a triester quaternary ammonium compound and wherein the diester quaternary ammonium compound is greater than 62 wt. % of the quaternary onium mixture, the triester quaternary ammonium compound is less than 17 wt. % of the quaternary onium mixture, and the fatty acids corresponding to the esters in the diester quaternary ammonium compound and the additional quaternary ammonium compound have a degree of unsaturation such that the iodine value of the fatty acids is from about 45 to about 58.

In the present invention, the organoclay used acts as a nanoclay mechanico-physical device which transfers interstitial energy caused by melt phase polymer immiscibility. The organoclay converts the interstitial energy into mechanical energy in the form of mechanical deformation. The resulting mechanical energy absorption decreases the size of the polymer domains and the blend behaves more like a uniform single phase material than do blends with no organoclay added.

Organoclays when blended with a polymer system typically exfoliate into a single crystal and disperse in the polymer forming nanocomposites. Organoclays can also act as plasticizers in a polymer. If the organoclay is not compatible with the polymer, the organoclay can precipitate inside the material resulting in decreased properties and rejection of the material. Organoclays can also disperse in the polymer but not fully exfoliate. When this occurs stacked multi-crystal arrangements called tactoids can form.

It has been found that organoclays can also act as compatibilizers in blends of polymers. A blend of two or more immiscible polymers is formed. This can be done in an extruder where the polymers are melted and blended together. To the blend is added an organoclay which is preferably smectite clay such as a montmorillonite clay that has been treated with a quaternary amine. Other quaternary amine treated smectite nanoclays include but are not limited to bentonite, montmorillonite, pyrophyllite, sauconite, saponite and montronite. The organoclay in the blend of immiscible polymers acts as a mechanical device more particularly a nano-scale mechanical device. The appropriate organic functional groups of the quaternary amine binds the polymer to the clay resulting in an anchoring effect where the clay has an affinity for only one polymer in the blend; the organoclay decreases the domain size of the polymer it is anchored to form a more homogeneous blend. A more homogeneous blend is also formed where the clay has an affinity to each of the polymers. The clay particle can absorb interstitial energy resulting from difficult surface energies for the different polymer domains at the interface. This mechanical energy absorption results in lower apparent interstitial energy and the polymer domains shrink under TEM visualization. This uniformity of the new blended material can be also illustrated by the appearance of one glass transition for uncompatibilized controls when using DMA (dynamic mechanical analysis). This homogenation, when not due to physico-chemical surfactant effects is due to the clay acting as a nanoscale spring which stores interstitial energy at polymer interfaces. This use is observed with quaternary amine treated smectites. The degree of deformation can be used to calculate the amount of interstitial energy absorbed by knowing the bending force used to deform a smectite crystal to a visually measurable degree. This is measured by using the angle of deformation and measuring the distance the deformation travels.

### DETAILED DESCRIPTION OF THE INVENTION

In accordance with the present invention, a more homogenous blend of two or more immiscible polymers are formed. Many polymers are immiscible when blended together. The present invention permits these polymers to be blended in a more homogenous blend than heretofore has been obtained. The immiscible polymers are blended with an organoclay. In one embodiment, a first polymer is melted and mixed with an organoclay. The blend of the first polymer with the organoclay is then further blended with a second polymer that is incompatible with the first polymer. The first polymer and the second polymer are normally immiscible when melted and blended together. The blend of the immiscible polymers blended with the organclay acts as a homogeneous blend due to the presence of the organoclay in the blend. The blend can be a blend not just of the first and second polymers but can include additional immiscible polymers as well.

In a second embodiment, a first and second immiscible polymer may be melt blended together. To the blend an organoclay is added. The mixture of two polymers and the organoclay are mixed together to form a relatively homogeneous blend of the two polymers. The blend can also be a blend of three or more immiscible polymers if desired.

As presently understood, the clay crystals of the organoclay absorb interstitial energy at the polymer-polymer interface in a blend of two or more immiscible polymers. It is also believed that the organoclay reduces a surface domain of at least one of the polymers in the blend.

When a blend of two or more immiscible polymers is usually formed and the glass transition temperature of the blend is measured, the result yields a peak for each polymer component of the immiscible polymer mixture. This is because the polymers form separate domains in the blend that are not compatible with each other. When the organoclay is present in a blend of two or more immiscible polymers, the domains are reduced creating a more homogenous blend.

The balance of the bending energy of the clay particle with the reduction of interfacial tension occurs according to the formula where F=bending force=absorbed interstitial energy. r=radius distance of bend from fulcrum point to distance traveled by crystal in bending:

$$F = γ ( n - m ) {l}^{2} + {γ}^{′} m {l}^{2} + mFbending$$

$$m = 3 V / 2 r {l}^{2}$$

$$F bending = \frac{Eh {ζ}^{4}}{{l}^{2}}$$

$$r = α 1 where \underline{{( 5 Eh )}^{1 / 4}} / ( 4 ( γ - {γ}^{′} ) )$$

When γ larger then the blend is more immiscible
n=number of exfoliated clay platelets
m=non exfoliated platelets or tactoids
sigma=interstitial energy
E=flexular modulus
h=Planks constant
gamma=interstitial energy of polymer A before an organoclay is added
gamma prime=interstitial energy of polymer after an organoclay is added
When γ larger then the blend is more immiscible
When r is smaller there is more efficient compatiblization

When the glass transition temperature is measured of such blends of the present invention separate multiple peaks for each polymer in the blend are not present and there is typically a single peak.

The preferred organoclay used in the present invention is made from a natural or synthetic clay, preferably a smectite clay. Suitable smectite clays include, but are not limited to, hectorite, montmorillonite, bentonite, beidelite, saponite, stevensite, and mixtures thereof. The organoclay is preferably treated with a quaternary amine as is known in the art. The quaternary amine may have one or more functional groups. Examples of the functional groups include but are not limited to amino, carboxyl, acylhalide, acyloxy, hydroxyl, isocyanato ureido, halo, epoxy and epicholorohydrin, etc.

There are a number of immiscible polymers that may be blended together. These polymer-polymer blends can include the following:

Polystyrene and Polyethylene or other polyolefine and blends thereof,

Maleic anhydride grafted polystyrene and a polyolefin or blends of polyolefin

EVA (Ethylene vinly acetate) and polyvinyl chloride

Maleic anhydride grafted polyvinyl chloride and EVA

Polyvinyl chloride and polycarbonate

Polyvinyl chloride and PMMA (polymethyl methacrylate)

PMMA (Polymethyl methacrylate) and Polyvinyl chloride

SAN(Styrene Acrylonitrile) and Polycarbonate

Polycarbonate and PCL (Polycaprolactam)

Polycarbonate and Polyolefin

Polycarbonate and Polyethylene

EVA and Polypropylene

Polyethylene and Polypropylene

Polyethylene and Polystyrene

ABS copolymer and Polyvinylchloride

Polyethylene and Polyvinylchloride

Polystyrene and Polyvinylchloride

Polycarbonate and Polypropylene

In the above blends the first polymer may be present in an amount of about 10% to about 90% by weight. The second polymer is present in an amount of about 10% to about 90% by weight. It will be appreciated that one or more other immiscible polymers may be added to the blends. In one embodiment to the polystyrene-polyethylene blend can be added for example a maleic anhydride grafted polystyrene or maleic anhydride grafted polyolefin in an amount of about 1% to about 15% by weight. In another embodiment, to any of the following blends about 1% to about 15% by weight of a maleic anhydride grafted component of one or both of the polymers may be added to the blend.

EVA-Polyvinyl Chloride blends

Polycarbonate-Polyvinyl chloride blends

PMMA (Polymethyl methacrylate) and Polyvinyl chloride

SAN(Styrene Acrylonitrile) and Polycarbonate

Polycarbonate and PCL (Polycaprolactam)

Polycarbonate and Polyolefin

Polycarbonate and Polyethylene

EVA and Polypropylene

Polyethylene and Polypropylene

Polyethylene and Polystyrene

ABS copolymer and Polyvinylchloride

Polyethylene and Polyvinylchloride

Polystyrene and Polyvinylchloride

Polycarbonate and Polypropylene

Thus, for example to the Polystyrene and Polyvinylchloride blend a maleic anhydride grafted polystyrene or maleic anhydride grafted polyvinyl chloride made be added to the blend in an amount of about 1% to about 15% by weight. Similarly, to. the Polyethylene and Polystyrene blend a maleic anhydride grafted polystyrene or maleic anhydride grafted polyolefin made be added to the blend in an amount of about 1% to about 15% by weight. There may be similar maleic anhydride components added to the other blends set out above.

What is claimed:

1. A method of forming a compatibilized blend of immiscible polymers comprising:
forming a melt blend of at least two immiscible polymers, adding to said blend an organoclay.

2. The method according to claim 1 wherein clay crystals of said organoclay absorbs interstitial energy at a polymer interface in said blend.

3. The method according to claim 2 wherein said organoclay reduces a surface domain of at least one of said polymers.

4. The method according to claim 3 wherein the blend has a single peak when the glass transition temperature is measured.

5. The method according to claim 1 wherein the organoclay is made from a natural or synthetic clay mineral selected from the group consisting of hectorite, montmorillonite, bentonite, beidelite, saponite, stevensite and mixtures thereof.

6. The method according to claim 5 wherein said organoclay has been treated with a quaternary amine.

7. The method according to claim 6 wherein the quaternary amine has one or more functional groups consisting of amino, carboxyl, acythalide acyloxy, hydroxyl, isocyanate ureido, halo, epoxy and epichlorohydren.

8. The method according to claim 4 wherein the organoclay has been exfoliated into polymer matrix.

9. The method according to claim 7 wherein said quaternary ammonium organoclay compound is made from a monoester, a diester or trimester quaternary ammonium compound or blends thereof.

10. The method according to claim 8 wherein the organoclay is the reaction product of a smectite clay with a quaternary onium compound mixture, wherein the quaternary onium compound mixture comprises a diester quaternary ammonium compound mixed with an additional quaternary ammonium compound, wherein the additional quaternary ammonium compound comprises a triester quaternary ammonium compound, a monoester quaternary ammonium compound, or mixtures thereof.

11. The method according to claim 10, wherein the diester quaternary ammonium compound is present as greater than 55 wt. % of the quaternary onium compound mixture.

12. The method according to claim 10, wherein the additional quaternary ammonium compound is a triester quaternary ammonium compound and wherein the triester quaternary ammonium compound comprises less than 25 wt. % of the quaternary onium compound mixture.

13. The method according to claim 10, wherein the fatty acids corresponding to the esters of the diester quaternary ammonium compound and the additional quaternary ammonium compound have a degree of unsaturation such that the iodine value is from about 20 to about 90.

14. The method according to claim 10, wherein the additional quaternary ammonium compound is a triester quaternary ammonium compound, and wherein the diester quaternary ammonium compound comprises greater than 60 wt. % of the quaternary onium mixtures, the triester quaternary ammonium compound comprises less than 20 wt. % of the quaternary onium mixture, and wherein the fatty acids corresponding to the esters in the diester quaternary ammonium compound and the additional quaternary ammonium compound have a degree of unsaturation such that the iodine value is from about 30 to about 70.

15. The method according to claim 10, wherein the additional quaternary ammonium compound is a triester quaternary ammonium compound, and wherein the diester quaternary ammonium compound comprises greater than 62 wt. % of the quaternary onium mixture, the triester quaternary ammonium compound comprises less than 17 wt. % of the quaternary onium mixture and wherein the fatty acids corresponding to the esters in the diester quaternary ammonium compound, and wherein the additional quaternary ammonium compound have a degree of unsaturation such that the iodine value is from about 40 to about 60.

16. The method according to claim 10, wherein the additional quaternary ammonium compound is a triester quaternary ammonium compound and wherein the diester quaternary ammonium compound comprises greater than 62 wt. % of the quaternary onium mixture, the triester quaternary ammonium compound comprises less than 17 wt. % of the quaternary onium mixture, and wherein the fatty acids corresponding to the esters in the diester quaternary ammonium compound and the additional quaternary ammonium compound have a degree of unsaturation such that the iodine value of the fatty acids is from about 45 to about 58.

17. The method according to claim 1 wherein the The balance of the bending energy of the clay particle with the reduction of interfacial tension occurs according to the formula where F=bending force=absorbed interstitial energy. r=radius distance of bend from fulcrum point to distance traveled by crystal in bending:
$$F = γ ( n - m ) {l}^{2} + {γ}^{′} m {l}^{2} + mFbending$$
$$m = 3 V / 2 r {l}^{2}$$
$$F bending = \frac{Eh {ζ}^{4}}{{l}^{2}}$$
$$r = α 1 where \underline{{( 5 Eh )}^{1 / 4}} / ( 4 ( γ - {γ}^{′} ) )$$
When γ larger then the blend is more immiscible
n=number of exfoliated clay platelets
m=non exfoliated platelets or tactoids
sigma=interstitial energy
E=flexular modulus
h=Planks constant
gamma=interstitial energy of polymer A before an organoclay is added
gamma prime=interstitial energy of polymer A after an organoclay is added

18. The method according to claim 1 wherein the transmission electron microscopy (TEM) imaging of the blend shows that organoclay crystals are at a polymer interface of the polymer blend's domains and said crystals are not planar and are visibly bent and if any clay crystals occur within a domain outside the interface then said clay crystals are not bent

19. A compatibilized blend of immiscible polymers comprising a blend of at least two immiscible polymers and an organoclay.

20. The blend according to claim 20 wherein clay crystals of said organoclay absorbs interstitial energy at a polymer interface in said blend.

21. The blend according to claim 21 wherein said organoclay reduces a surface domain of at least one of said polymers.

22. The blend according to claim 22 wherein the blend has a single peak when the glass transition temperature is measured.

23. The blend according to claim 20 wherein the organoclay is made from a natural or synthetic clay mineral selected from the group consisting of hectorite, montmorillonite, bentonite, beidelite, saponite, stevensite and mixtures thereof.

24. The blend according to claim 24 wherein said organoclay has been treated with a quaternary amine.

25. The blend according to claim 25 wherein the quaternary amine has one or more functional groups consisting of amino, carboxyl, acythalide acyloxy, hydroxyl, isocyanate ureido, halo, epoxy and epichlorohydren.

26. The blend according to claim 23 wherein the organoclay has been exfoliated into polymer matrix.

27. The blend according to claim 26 wherein said quaternary ammonium organoclay compound is made from a monoester, a diester or trimester quaternary ammonium compound or blends thereof.

28. The blend according to claim 27 wherein the organoclay is the reaction product of a smectite clay with a quaternary onium compound mixture, wherein the quaternary onium compound mixture comprises a diester quaternary ammonium compound mixed with an additional quaternary ammonium compound, wherein the additional quaternary ammonium compound comprises a triester quaternary ammonium compound, a monoester quaternary ammonium compound, or mixtures thereof.

29. The blend according to claim 29, wherein the diester quaternary ammonium compound is present as greater than 55 wt. % of the quaternary onium compound mixture.

30. The blend according to claim 29, wherein the additional quaternary ammonium compound is a triester quaternary ammonium compound and wherein the triester quaternary ammonium compound comprises less than 25 wt. % of the quaternary onium compound mixture.

31. The blend according to claim 29, wherein the fatty acids corresponding to the esters of the diester quaternary ammonium compound and the additional quaternary ammonium compound have a degree of unsaturation such that the iodine value is from about 20 to about 90.

32. The blend according to claim 29, wherein the additional quaternary ammonium compound is a triester quaternary ammonium compound, and wherein the diester quaternary ammonium compound comprises greater than 60 wt. % of the quaternary onium mixtures, the triester quaternary ammonium compound comprises less than 20 wt. % of the quaternary onium mixture, and wherein the fatty acids corresponding to the esters in the diester quaternary ammonium compound and the additional quaternary ammonium compound have a degree of unsaturation such that the iodine value is from about 30 to about 70.

33. The blend according to claim 29, wherein the additional quaternary ammonium compound is a triester quaternary ammonium compound, and wherein the diester quaternary ammonium compound comprises greater than 62 wt. % of the quaternary onium mixture, the triester quaternary ammonium compound comprises less than 17 wt. % of the quaternary onium mixture and wherein the fatty acids corresponding to the esters in the diester quaternary ammonium compound, and wherein the additional quaternary ammonium compound have a degree of unsaturation such that the iodine value is from about 40 to about 60.

34. The blend according to claim 29, wherein the additional quaternary ammonium compound is a triester quaternary ammonium compound and wherein the diester quaternary ammonium compound comprises greater than 62 wt. % of the quaternary onium mixture, the triester quaternary ammonium compound comprises less than 17 wt. % of the quaternary onium mixture, and wherein the fatty acids corresponding to the esters in the diester quaternary ammonium compound and the additional quaternary ammonium compound have a degree of unsaturation such that the iodine value of the fatty acids is from about 45 to about 58.

35. The blend according to claim 19 wherein the balance of the bending energy of the clay particle with the reduction of interfacial tension occurs according to the formula where F=bending force=absorbed interstitial energy. r=radius distance of bend from fulcrum point to distance traveled by crystal in bending:
$$F = γ ( n - m ) {l}^{2} + {γ}^{′} m {l}^{2} + mFbending$$
$$m = 3 V / 2 r {l}^{2}$$
$$F bending = \frac{Eh {ζ}^{4}}{{l}^{2}}$$
$$r = α 1 where \underline{{( 5 Eh )}^{1 / 4}} / ( 4 ( γ - {γ}^{′} ) )$$
When γ larger then the blend is more immiscible
n=number of exfoliated clay platelets
m=non exfoliated platelets or tactoids
sigma=interstitial energy
E=flexular modulus
h=Planks constant
gamma=interstitial energy of polymer A before an organoclay is added
gamma prime=interstitial energy of polymer A after an organoclay is added

36. The blend according to claim 19 wherein the transmission electron microscopy (TEM) imaging of the blend shows that organoclay crystals are at a polymer interface of the polymer blend's domains and said crystals are not planar and are visibly bent and if any clay crystals occur within a domain outside the interface then said clay crystals are not bent
